(19) United States
(12) Patent Application Publication
(10) Pub. No.: US 2008/0157419 A1
(43) Pub. Date: Jul. 3, 2008

(54) WET METHOD OF MANUFACTURING ELECTROLYTE-IMPREGNATED ELECTRODES FOR MOLTEN CARBONATE FUEL CELL

(75) Inventors: Bo Hyun Ryu, Daejeon (KR); Yun Sung Kim, Daejeon (KR); Chang-Sung Jun, Daejeon (KR); MiYoung Shin, Daejeon (KR)

Correspondence Address: LUCAS & MERCANTI, LLP, 475 PARK AVENUE SOUTH, 15TH FLOOR, NEW YORK, NY, 10016, US

(73) Assignee: DOOSAN HEAVY INDUSTRIES & CONSTRUCTION CO., LTD., Gyeongsangnam-do (KR)

(21) Appl. No.: 11/966,188

(22) Filed: Dec. 28, 2007

(30) Foreign Application Priority Data
Dec. 29, 2006 (KR) 10-2006-0138383
Dec. 24, 2007 (KR) 10-2007-0136025

(51) Int. Cl. C04B 35/64

(52) U.S. Cl. 264/104

(57) ABSTRACT

Disclosed herein is a method of manufacturing electrolyte-impregnated anode and cathode for a molten carbonate fuel cell. The method is intended to manufacture electrolyte-impregnated electrodes for controlling an electrolyte present in unit cells of a molten carbonate fuel cell by adding electrolyte powder to prepare an electrolyte slurry, which is necessary for forming electrodes, molding electrodes containing an electrolyte in an in-situ state so that they meet the specifications for the unit cells of a fuel cell stack using a tape casting method, and then sintering the electrodes. The method includes preparing electrolyte slurry, nickel slurry and organic substance slurry; mixing the electrolyte slurry with the nickel slurry and the organic substance slurry to form mixed slurry; defoaming the mixed slurry; tape-casting the mixed slurry; and drying and sintering the tape-cast slurry.

### BACKGROUND OF THE INVENTION

1. Field of the Invention

The present invention relates to a method of manufacturing electrolyte-impregnated electrodes for a molten carbonate fuel cell, and, more particularly, to a method of manufacturing electrolyte-impregnated electrodes for controlling an electrolyte present in unit cells of a molten carbonate fuel cell by adding electrolyte powder to prepare electrolyte slurry necessary for forming electrodes, molding electrodes containing an electrolyte to meet specifications for unit cells of a fuel cell stack using a tape casting method, and then sintering the electrodes.

2. Description of the Related Art

As a conventional technology, Korean Patent Publication No. 2000-0003203 discloses a method of manufacturing a unit cell of a fuel cell stack, including the steps of calculating the amount of electrolyte necessary for each unit cell constituting a molten carbonate fuel cell stack such that the amount thereof corresponds to 30%, 20% and 100% of the total pore volume of each of a cathode, an anode and a matrix; fabricating a quantity of electrolyte plates corresponding to the amount thereof; and sequentially layering the cathode, electrolyte plate, matrix, electrolyte plate and anode. This method is characterized in that the electrolyte plates are fabricated using a mixed salt in which lithium carbonate is mixed with potassium carbonate and sodium carbonate and is then pulverized.

However, this method is problematic in that the electrolyte plates are impregnated in the cathode, anode and matrix while being melted during a pretreatment process for the molten carbonate fuel cell stack, and thus the height corresponding to the thickness of the electrolyte plates is lost, thereby decreasing the total height of the fuel cell stack, and in that the electrolyte plates are nonuniformly melted during the pretreatment process, so that plane clamping force is nonuniformly distributed, thereby decreasing the mechanical stability of the fuel cell stack.

Furthermore, this method is problematic in that electrolyte falls between unit cells and is thus lost, so that the amount of electrolyte is less than a desired amount from the beginning of operation, thereby decreasing the performance of the fuel cell and shortening the lifespan thereof.

Meanwhile, as another technology, there is a method of impregnating electrodes with an electrolyte by placing an electrolyte on sintered electrodes and then heating the electrodes in order to control the electrolyte. This method include a method of impregnating electrodes with an electrolyte by preparing electrolyte slurry, dispersing the electrolyte slurry in sintered electrodes, drying the electrodes dispersed with the slurry and then reheating the dried electrodes, and a method of impregnating electrodes with an electrolyte by placing an electrolyte plate on electrodes and then reheating the electrodes.

However, this method is also problematic in that, in order to remove excessively-contained organic substances from the electrolyte or slurry, a two-step process, in which first heat-treatment is conducted at a temperature of 450° C. or lower in an oxidation atmosphere and then second heat-treatment is conducted at a temperature of 450° C. or higher in a reduction atmosphere, is performed, or a process for removing the organic substances using a continuous sintering furnace, thus decreasing workability, and in that electrodes are warped during a process of drying electrolyte slurry, or are warped due to the difference in density between the electrode and the electrolyte during a process of cooling the electrolyte in the heat-treatment, thus decreasing flatness and generating cracks. For this reason, this method is disadvantageous in that various attempts to increase yield must be made.

### SUMMARY OF THE INVENTION

Accordingly, the present invention has been made to solve the above problems occurring in the prior art, and an object of the present invention is to provide a method of manufacturing electrolyte-impregnated electrodes for controlling an electrolyte present in unit cells of a molten carbonate fuel cell by adding electrolyte powder to prepare electrolyte slurry necessary for forming electrodes, molding electrodes containing an electrolyte to meet specifications for unit cells of a fuel cell stack using a tape casting method, and then sintering the electrodes.

The present invention provides a method of manufacturing electrolyte-impregnated electrodes by directly applying electrode green sheets containing an electrolyte to a fuel cell stack in an in-situ state or only the electrolyte-impregnated electrode green sheets are sintered in the furnace and applied to the fuel cell stack, as described in the above technologies.

Further, the present invention provides a method of manufacturing electrolyte-impregnated electrodes having a desired pore structure by separately preparing electrolyte slurry, nickel powder slurry and organic substance slurry and then uniformly mixing the three slurries to form mixed slurry. Here, in order to control the pore structure of electrolyte-impregnated electrodes, the particle size of the electrolyte powder and the amount of the electrolyte must be controlled.

In order to accomplish the above object, the present invention provides a method of manufacturing electrolyte impregnated electrodes for a molten carbonate fuel cell using a wet process, including the steps of preparing electrolyte slurry, nickel slurry and organic substance slurry, respectively; mixing the electrolyte slurry with the nickel slurry and the organic substance slurry to form a mixed slurry; defoaming the mixed slurry; tape-casting the mixed slurry; and drying and sintering the tape-cast slurry.

The electrolyte slurry may be formed by mixing lithium powder with at least one of potassium carbonate powder and sodium carbonate powder, and the electrolyte slurry may occupy 20˜100% of the total pore volume of the electrodes.

Furthermore, the lithium carbonate powder may be formed by mixing lithium carbonate powder having a particle diameter of 10 μm or more with lithium carbonate powder having a particle diameter of 2 μm or less at a ratio of 1:1, and at least one of the potassium carbonate powder and the sodium carbonate powder, which are mixed with the lithium carbonate powder, may have a particle diameter ranging from 1 to 3 μm.

In the method, it is preferred that lithium carbonate-potassium carbonate or lithium carbonate-sodium carbonate be melted into a eutectic salt having a uniform composition or a slightly changeable composition, and the eutectic salt be cooled and pulverized to form powder having a particle size of 5 μm or less, and then the powder be used to prepare slurry.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a method of manufacturing electrolyte-impregnated electrodes for a molten carbonate fuel cell using a wet process according to the present invention; and

FIG. 2 is a graph showing the pore distribution of a cathode sheet manufactured by mixing lithium carbonate and potassium carbonate such that the mixing ratio of the lithium carbonate to the potassium carbonate is 70 mol %:30 mol % and then sintering the cathode green sheet in the electrolyte-impregnated electrodes manufactured through the method of FIG. 1, compared to that of a conventional cathode.

### DESCRIPTION OF THE PREFERRED EMBODIMENTS

Hereinafter, the method of manufacturing electrolyte-impregnated electrodes for a molten carbonate fuel tell using a wet process according to the present invention will be described in detail with reference to the attached drawings.

The method of manufacturing electrolyte-impregnated electrodes for a molten carbonate fuel cell using a wet process according to the present invention includes the steps of preparing primary slurry, including an organic substance, nickel powder and a solvent; preparing a secondary slurry, having various particle diameters, including lithium carbonate, potassium carbonate, sodium carbonate, and the like; preparing a tertiary slurry including organic substances, such as binders, plasticizers and the like; and preparing a final slurry by mixing the primary slurry with the secondary slurry and the tertiary slurry.

The total pore volume of the electrodes is calculated based on the size of the electrodes formed in proportion to the size of unit cells constituting a fuel cell stack, and an electrolyte, which can occupy 20˜100% of the total volume of the electrodes depending on the pore size and porosity of the electrodes, must be mixed with the prepared final slurry.

In this case, since the pore size distribution is very important, the particle diameter of the powder constituting the electrolyte slurry must be determined so as to set an appropriate rate of addition, based on a theoretically calculated filling rate.

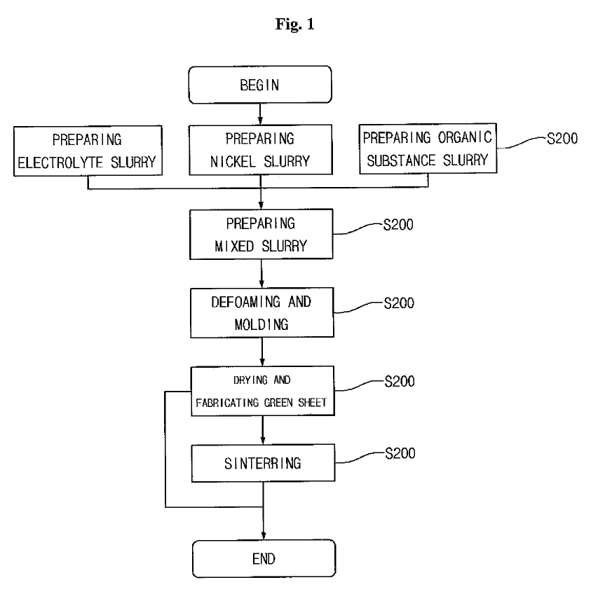

Referring to FIG. 1, the method of manufacturing electrolyte-impregnated electrodes for a molten carbonate fuel cell using a wet process according to the present invention includes a wet process (S100, S200) for preparing slurry, a mixing process (S300) for mixing electrolyte slurry with nickel slurry, a molding process (S400) and a sintering process (S500).

Here, the wet process (S100, S200) is a process of preparing electrolyte slurry, nickel slurry and organic substance slurry, and the mixing process (S300) is a process of mixing the electrolyte slurry with the nickel slurry and the organic substance slurry to form mixed slurry and then milling the mixed slurry. Further, the molding process (S400) is a process of defoaming and tape-casting the mixed slurry at a predetermined size. The electrodes of the present invention are manufactured through the above processes. The electrodes manufactured through the above processes are formed into green sheets and then used for a molten carbonate fuel cell, or they are directly used for a molten carbonate fuel cell after the sintering process (S500).

The nickel slurry is slurry prepared by primarily milling a defoamer, a dispersant and a plasticizer with a solvent, adding nickel powder to the primarily-milled mixture and then secondarily milling the primarily-milled mixture. Nickel is known as a metal which is used as a main raw material of electrode, in which the amount of nickel is 90% or more of the amount of electrode. In the case where the electrode is an anode, a small amount of chromium may further added to the nickel slurry, and nickel-aluminum alloy powder or nickel powder coated with aluminum may be used as a raw material. In the case where the electrode is a cathode, nickel powder or nickel powder coated oxides, such as alumina etc., as an additive for improving physical properties, may be used as a raw material.

The electrolyte slurry may be prepared using the following two methods. First, the electrolyte slurry is prepared by milling mixed powder, in which lithium carbonate (Li₂CO₃) powder is mixed with at least one of potassium carbonate (K₂CO₃) powder and sodium carbonate (Na₂CO₃) powder, with a solvent. That is, the electrolyte slurry is prepared by mixing lithium carbonate with any one of potassium carbonate and sodium carbonate to form a mixed salt, adding carbonate containing any one selected from the group consisting of Rb, Cs, Cd, Ca, Sr, Da and Mg to the mixed salt such that the amount of the carbonate is 15 mol % or less, and then pulverizing or milling the mixed salt. Second, the electrolyte slurry is prepared by melting mixed powder, in which lithium carbonate (Li₂CO₃) powder is mixed with at least one of potassium carbonate (K₂CO₃) powder and sodium carbonate (Na₂CO₃) powder, finely pulverizing the mixed powder, and then milling the mixed powder using a solvent to which a dispersant is added. That is, the electrolyte slurry is prepared by mixing lithium carbonate with any one of potassium carbonate and sodium carbonate to form a mixed salt electrolyte, adding carbonate containing any one selected from the group consisting of Rb, Cs, Gd, Ca, Sr, Ba and Mg to the mixed salt electrolyte such that an amount of the carbonate is 15 mol % or less, and then melting, cooling and then pulverizing the mixed salt electrolyte. In this case, the electrolyte powder is uniformly distributed in the solvent by the dispersant. This electrolyte slurry is formed such that it is suitable for a three-phase or two-phase eutectic salt composition, in which lithium carbonate is mixed with potassium carbonate and/or sodium carbonate. Here, it is preferred that the composition of the eutectic salt can be changed and the amount of the eutectic salt can occupy 20˜100% of the total pore volume of each of the electrodes.

Moreover, in order to set the pore volume of the electrodes so that it includes both large pores, which serving as gas passages, and small pores, which are impregnated with an electrolyte, when the mixed salt is used, the electrolyte slurry must be formed into electrolyte powder by adjusting the size of one of the above three carbonate powders, such as lithium carbonate, potassium carbonate and sodium carbonate powders, or must be formed into electrolyte powder by adjusting the size of the eutectic salt.

For example, in consideration of the amount of lithium consumed during the pretreatment process for the molten carbonate fuel cell stack, the composition ratio of lithium carbonate to potassium carbonate is set to a ratio of 70 mol %:30 mol %. The amount of the electrolyte which is to be impregnated in the electrodes is determined by calculating the amount of electrolyte per unit cell of the fuel cell stack.

In order to simultaneously form the above large pores and small pores in the electrodes, lithium carbonate powder having a particle diameter of 10 μm or more is mixed with lithium carbonate powder having a particle diameter of 2 μm or less at a ratio of 1:1. Here, the term “particle diameter” means the diameter of the powder particles.

At least one of the potassium carbonate powder and the sodium carbonate powder, which are mixed with the lithium carbonate powder, may have a particle diameter ranging from 1 to 3 μm, and more preferably ranging from 0.5 to 3 μm when the mixed powder is melted and then pulverized.

The organic substance slurry is added in order to finally form electrodes, and is used to bond the powders included in the respective slurries with each other. Further, the organic substance slurry includes at least one of PVB, PVA and PVC depending on the molecular weight of the synthetic resin used as a binder. Such a binder serves to adjust the pore distribution of the electrodes.

The nickel slurry, electrolyte slurry and organic substance slurry, prepared as above, are mixed with each other to form mixed slurry, the foam and solvent included in the mixed slurry are removed therefrom using a vacuum pump to adjust the viscosity thereof through a defoaming process, and then the defoamed mixed slurry is continuously formed into green sheets having predetermined width and thickness based on the unit cell standards for fuel cell stacks and then dried through a tape casting process. Subsequently, according to the use of electrodes, the green sheets are cut in proportion to the unit cell standards for fuel cell stacks, and then the cut green sheets are directly used, or are used after they are sintered. Here, since the defoaming and tape-casting process (S400) and the drying and sintering process (S500) are also performed in general fuel cell electrodes manufacturing methods, a description thereof will be omitted.

The technical spirit of the present invention resides in the method of integrally manufacturing electrolyte-impregnated electrodes by preparing nickel slurry, electrolyte slurry and organic substance slurry using a wet process and then mixing them.

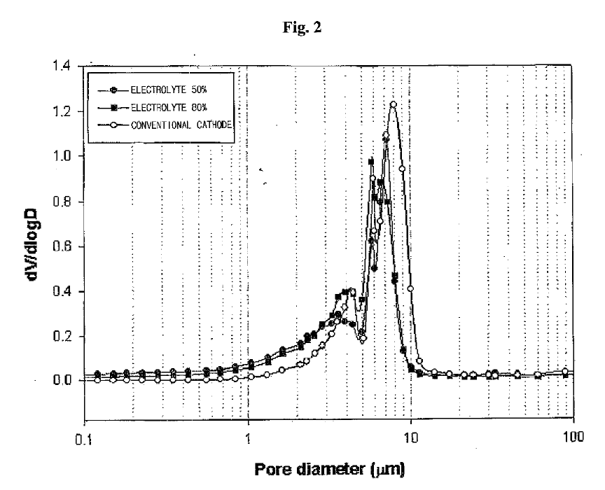

Referring to FIG. 2, it can be seen that the pore size distribution of the cathode manufactured using the above method of the present invention is a bimodal pore size distribution having two main peaks, like the pore size distribution of a conventional cathode.

As described above, the method of manufacturing electrolyte-impregnated electrodes for a molten carbonate fuel cell using a wet process according to the present invention is advantageous in that an electrolyte, the amount of which is determined in consideration of the specification of unit cells constituting a fuel cell stack, can be sufficiently supplied, so that the change in the height of the fuel cell stack, occurring in the conventional fuel cell stack pretreatment process, is prevented, thereby ensuring the mechanical stability of fuel cell stack.

Further, the method of manufacturing electrolyte-impregnated electrodes for a molten carbonate fuel cell according to the present invention, compared to the conventional methods, is advantageous in that the method is performed through a series of continuous processes, thus improving workability, reducing production costs and producing the electrodes in large quantities.

Furthermore, the method of manufacturing electrolyte-impregnated electrodes for a molten carbonate fuel cell according to the present invention is advantageous in that, when the electrolyte-impregnated cathode is directly used for the molten carbonate fuel cell in an in-situ state in which the mixed slurry is tape-cast, a sintering process is not additionally performed, thus simplifying the processes and securing economic efficiency, and in that, when the electrolyte-impregnated cathode is used for the molten carbonate fuel cell after the sintering process is performed, since a mixed salt is melted into a eutectic salt, actual melting point of electrolyte can be decreased in the furnace, and since an electrolyte having the same composition is uniformly distributed in the electrodes, mechanical instability caused by nonuniform melting can be removed in the fuel cell stack.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing electrolyte-impregnated electrodes for a molten carbonate fuel cell using a wet process, comprising:
preparing electrolyte slurry, nickel slurry and organic substance slurry;
mixing the electrolyte slurry with the nickel slurry and the organic substance slurry to form a mixed slurry;
defoaming the mixed slurry;
tape-casting the mixed slurry; and
drying and sintering the tape-cast slurry.

2. The method according to claim 1, wherein the electrolyte slurry is prepared by mixing lithium carbonate powder with at least one of potassium carbonate powder and sodium carbonate powder to form a mixed salt, adding carbonate containing any one selected from the group consisting of Rb, Cs, Cd, Ca, Sr, Ba and Mg to the mixed salt as an additive, and then pulverizing or milling the mixed salt, or melting the mixed salt and then pulverizing it, and the amount of the electrolyte slurry occupies 20˜100% of the total pore volume of the electrodes.

3. The method according to claim 1, wherein, in the case where the electrode is an anode, the nickel slurry is prepared by mixing nickel powder with chromium powder, coating nickel powder with aluminum powder, or using nickel-aluminum alloy powder.

4. The method according to claim 1, wherein, in the case where the electrode is a cathode, the nickel slurry is prepared by using nickel powder as a main raw material or adding oxides or compounds, which can form the oxides, to the nickel powder.

5. The method according to claim 1, wherein, in the mixing the electrolyte slurry with the nickel slurry and the organic substance slurry, the electrolyte slurry is uniformly mixed with the nickel slurry and the organic substance slurry, and an amount of the impregnated electrolyte is determined by an amount of the electrolyte slurry and occupies 20˜100% of the total pore volume of a fuel cell stack.

6. The method according to claim 1, wherein, in the drying and sintering the mixed slurry, green sheets, which are completed after the drying, is directly applied to a fuel cell stack depending on the use thereof.

7. The method according to claim 6, wherein an anode green sheet and a cathode green sheet are applied to the fuel cell stack and are then sintered in an in-situ state.

8. The method according to claim 1, wherein, in the drying and sintering the mixed slurry, green sheets, which are completed after the drying, are sintered in the furnace and then are manufactured into an electrolyte-impregnated anode and an electrolyte-impregnated cathode, and then applied to a fuel cell stack depending on the use thereof.

9. The method according to claim 2,
wherein the lithium carbonate powder is formed by mixing lithium carbonate powder having a particle diameter of 10 μm or more with lithium carbonate powder having a particle diameter of 2 μm or less at a ratio of 1:1, and
wherein at least one of the potassium carbonate powder and the sodium carbonate powder, which are mixed with the lithium carbonate powder, has a particle diameter ranging from 1 to 3 μm.

10. The method according to claim 2, wherein the electrolyte slurry is a eutectic salt electrolyte, which prepared by mixing lithium carbonate with any one of potassium carbonate and sodium carbonate to form a mixture, and then melting, cooling and then pulverizing the mixture.

11. The method according to claim 2, wherein the electrolyte slurry is an electrolyte, which is prepared by mixing lithium carbonate with any one of potassium carbonate and sodium carbonate to form a mixed salt electrolyte, adding carbonate containing any one selected from the group consisting of Rb, Cs, Gd, Ca, Sr, Ba and Mg to the mixed salt electrolyte such that an amount of the carbonate is 15 mol % or less, and then melting, cooling and then pulverizing the mixed salt electrolyte.

12. The method according to claim 2, wherein the electrolyte slurry is an electrolyte, which is prepared by mixing lithium carbonate with any one of potassium carbonate and sodium carbonate to form a mixed salt, adding carbonate containing any one selected from the group consisting of Rb, Cs, Od, Ca, Sr, Ba and Mg to the mixed salt such that an amount of the carbonate is 15 mol % or less, and then pulverizing or milling the mixed salt.
